(19) United States
(12) Patent Application Publication
(10) Pub. No.: US 2011/0240404 A1
(43) Pub. Date: Oct. 6, 2011

(54) DISPOSABLE SAWHORSE

(76) Inventor: KIRBY WOODARD, HUMBLE, TX (US)

(21) Appl. No.: 12/752,747

(22) Filed: Apr. 1, 2010

(51) Int. Cl. B25H 1/06

(52) U.S. Cl. 182/181.1

(57) ABSTRACT

A sawhorse comprises a top rail for supporting an item placed on the sawhorse. The top rail defines at least four slots with at least two of the at least four slots located on lateral sides of the top rail. At least four leg members support the top rail. A first end of the at least four leg members engages the corresponding slot of the at least four slots to form a joint. Responsive to a downward force applied to the top rail by the item placed on the sawhorse, the first end of each of the at least four members will tilt within the corresponding slot within the top rail causing sides of the first end to engage the sides of the slot to stabilize the joint.

### TECHNICAL FIELD

The present invention relates to sawhorses, and more particularly to disposable sawhorses.

### BACKGROUND

Sawhorses are utilized in construction and industrial applications for supporting construction materials while a worker cuts or otherwise works upon material supported by the sawhorse. Sawhorses of this type generally have rather loose interconnections between a crosspiece and support legs that can often limit the amount of weight supportable by the sawhorse. Thus, there is a need for providing a sawhorse capable of supporting large weights using a secure structure that is not adversely affected by larger weights placed upon the sawhorse structure.

### SUMMARY

The present invention, as disclosed and described herein, in one aspect thereof, comprises a sawhorse comprising a top rail that supports an item placed on the sawhorse. The top rail defines at least four slots with at least two of the at least four slots located on lateral sides of the top rail. At least four leg members support the top rail. A first end of the at least four leg members engages the corresponding slot of the least four slots to form a joint. Responsive to a downward force applied to the top rail by an item placed on the sawhorse, the first end of each of the at least four leg members will tilt within the corresponding slot within the top rail causing sides of the first end to engage sides of the slot to stabilize the joint.

### BRIEF DESCRIPTION OF THE DRAWINGS

For a more complete understanding, reference is now made to the following description taken in conjunction with the accompanying Drawings in which:

FIG. 1 is a perspective view of the sawhorse of the present disclosure;

FIG. 2 provides an exploded perspective view of the sawhorse of FIG. 1;

FIG. 3 provides a cutaway view more fully illustrating the connection between the leg members and the top rail;

FIG. 4 more fully illustrates the joint interconnecting the leg member with the top rail;

FIG. 5 illustrates the rotation of the leg dovetail in the top rail dovetail slot;

FIG. 6 is a cutaway view illustrating interconnection between the leg members and the cross brace;

FIG. 7 more fully illustrates the joint interconnecting the leg members with the cross brace; and

FIG. 8 illustrates the rotation of the second leg dovetail in the cross brace dovetail slot.

### DETAILED DESCRIPTION

Referring now to the drawings, wherein like reference numbers are used herein to designate like elements throughout, the various views and embodiments of a portable sawhorse are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

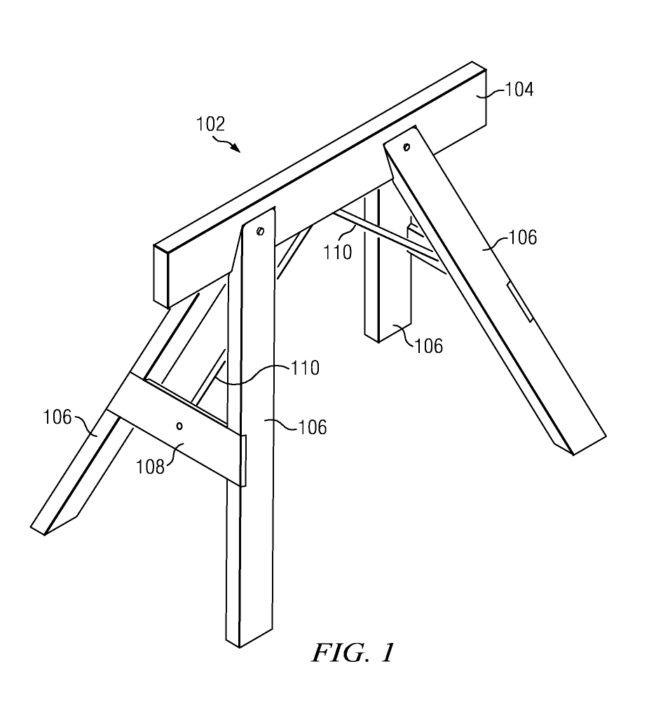

Referring now to the drawings, and more particularly to FIG. 1, there is illustrated a perspective view of the sawhorse 102. The sawhorse 102 includes a top rail 104 on which a structure being supported by the sawhorse may be placed. The top rail 104 is supported by four separate leg members 106 that slide into associated inset slots of the top rail 104 as will be more fully described hereinbelow. The leg members 106 form a right leg assembly 10 and a left leg assembly 10. The leg members 106 in one embodiment extend at an angle of 20 degrees from the vertical axis running through the top rail 104. This creates an angle of 40 degrees between each of the leg members 108 within a paired leg assembly. While the present implementation describes an angle of 20 degrees between the leg members 106 and the top rail 104, other angles may of course be utilized as will be appreciated by one skilled in the art. The leg members 106 are supported from spreading apart from each other by a cross brace 108. The cross brace 108 prevents the leg members 106 from separating from each other along the axis running generally parallel to the cross brace 108. The cross brace 108 is connected to leg members 106 via a joint which will be more fully described hereinbelow. Each leg member 106 is connected with a second leg member 106 via the cross brace 108 to form either the right leg assembly 10 or left leg assembly 10.

Additionally, the pairs of leg members 106 interconnected via the cross brace 108 are prevented from separating in a direction along the long axis of the top rail 104 by rail braces 110. The rail braces 110 are connected to the inside face of the cross braces 108 and are connected together at a single point on the bottom side of the top rail 104. The rail braces 110 prevent the leg members 106 of the sawhorse 102 from separating when strong pressure is applied to the top rail 104 in a downward direction. By connecting the rail braces 110 at a single point under the top rail 104, the opposing pressures on the leg assemblies comprising two leg members 106 and a cross brace 108 to be equally distributed between the leg assemblies.

In one embodiment, the top rail 104, leg members 106 and cross braces 108 are made from white pine wood. However, other types of materials may be utilized in manufacturing these parts. The cross braces 108 comprise pine plywood but may also comprise other materials. In a preferred embodiment, the rail brace 110 consists of cold roll steel, aluminum, wood or similar type of supporting material. However, other materials and sizes of the rail braces 110 could also be utilized.

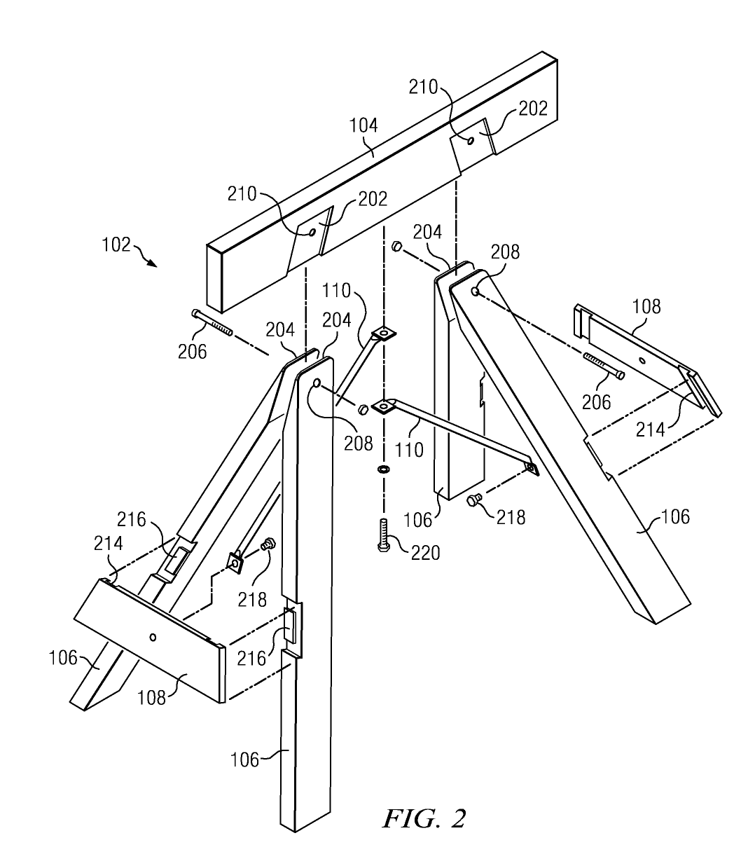

Referring now to FIG. 2, there is illustrated an exploded perspective view of the portable sawhorse 102. The illustration in FIG. 2 more fully illustrates the interconnection between the top rail 104 and each of the leg members 106. The top rail 104 defines in each lateral side thereof, dovetail slots 202. The dovetail slot 202 includes a dovetail cut on each of the closed sides of the dovetail slot 202. While the present embodiment describes a dovetail cut on each of the dovetail slot 202 other types of joint connections can be used. Additionally, the dovetail slot may just comprise an inset slot that the leg members can slide into. The dovetail slots 202 are configured to receive the upper ends of the leg members 106, which have a dovetail defined therein. The dovetail slots 202 are angled with respect to the vertical axis of the top rail. The dovetailed end 204 of each of the leg members 106 are slid into the dovetail slot 202 from the bottom toward the top of the top rail 104. Once each of the dovetailed ends 204 of the leg members 106 are slid into the dovetailed slots 202 of the top rail 104, a bolt 206 may be slid through a hole 208 defined in each of the leg members 106 through a corresponding hole 210 within the dovetailed slot 202 of the top rail 104. A nut 212 may then be threaded onto the opposite side of the bolt 206 to provide additional securing of the top rail 104 to the leg members 106.

Each of the cross braces 108 define a dovetail slot 214 on each side thereof for engaging a corresponding dovetail 216 defined on the outer edge of each of the leg members 106. The spreading motion of the leg members 106 responsive to the placement of weight upon the top rail 104 provides a locking action between the dovetails 216 and dovetail slots 214 providing more stability and support to the sawhorse 102 as will be described more fully hereinbelow.

The rail braces 110 are connected to the inner faces of the cross braces 108 at the bottom ends via a screw or bolt 218. Similarly, the upper ends of the rail braces 110 are connected to the bottom of the top rail 104 via a single bolt or screw 220 passing through each of the second ends of the rail braces 110 into the bottom of the top rail 104.

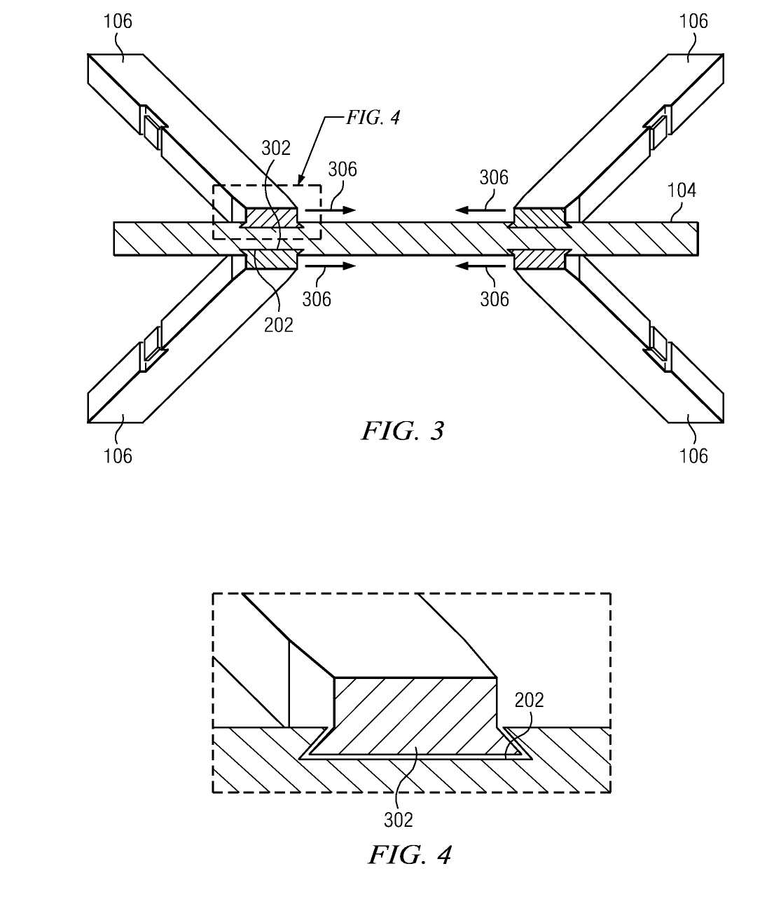

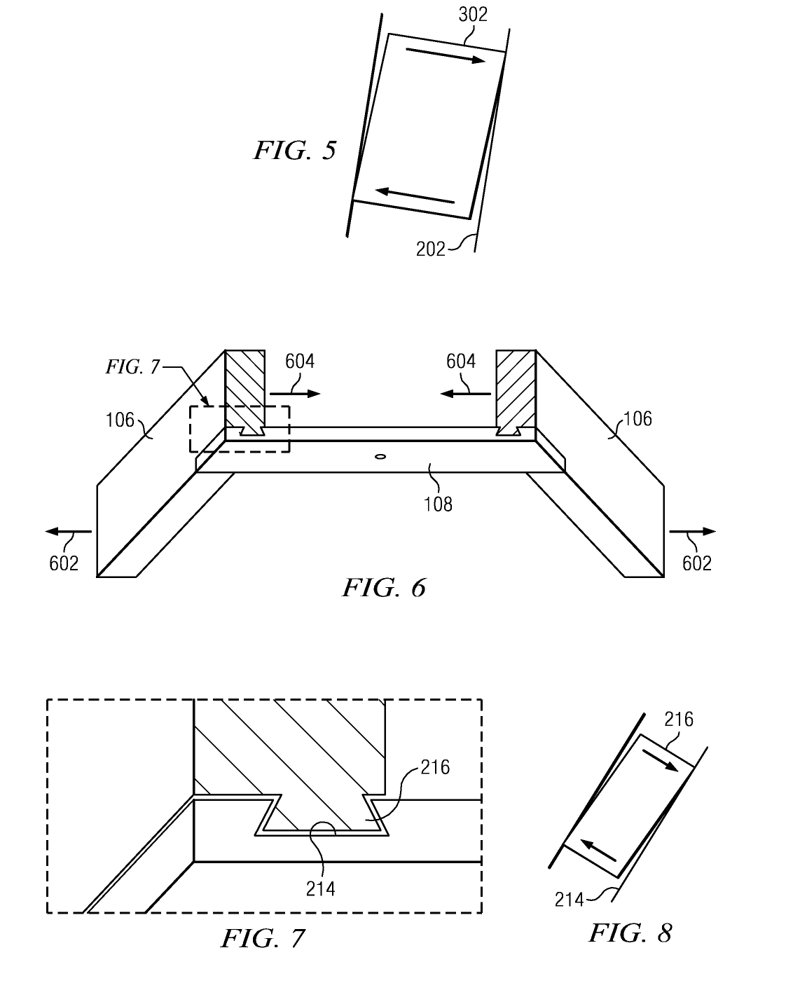

Referring now to FIG. 3, there is illustrated a cutaway view more fully illustrating the joint interconnecting the top rail 104 with each of the leg members 106. The dovetail 302 is inserted within the dovetail slot 202 at four separate locations on opposing lateral sides of the top rail 104 wherein each of the leg members 106 interfaces with the top rail 104. Interconnection of the dovetail 302 within the dovetail slot 202 is more fully illustrated in FIG. 4. When a weight is placed upon the top rail 104 and forces it down, this causes the top portion of the leg member 106 to move generally in the directions indicated by the arrows 306 in FIG. 3. This causes the dovetail 302 to slightly tilt within the dovetail slot 202 as generally illustrated in FIG. 5. Thus, one side of the dovetail 302 will wedge against one side of the dovetail slot 202 and the other side of the dovetail 302 will wedge against the opposite side of the dovetail slot 202 forming a tighter joint between the leg members 106 and the top rail 104. This tilt is due to the angle of the dovetail slot 202 with respect to the vertical axis of the top rail 104 opposing the downward force in the direction of the vertical axis of the top rail of an item placed on the sawhorse. If only an inset slot or other type of joint were used rather than the dovetail slot a similar action would take place.

Referring now to FIG. 6, there is illustrated a cutaway view illustrating the joint interconnecting the leg members 106 with a cross brace 108. As discussed previously, the cross brace 108 defines a pair of dovetail slots 214 as illustrated in FIG. 7 on each side of the cross brace 108. A simple inset slot or other types of joint may also be utilized. Additionally, the leg members 106 define a dovetail 216 for interconnecting the cross brace members 106 with the cross brace 108. Responsive to a downward force being placed upon the top rail 104, the leg member 106 will tend to tilt within the dovetail slots 214 in the manner illustrated generally in FIG. 8. This causes one side of the dovetail 216 to strongly engage one portion of the dovetail slots while the opposite side of the dovetail 216 engages the opposite side of the dovetail slot 214 forming a tighter, more stable connection between the leg members 106 and the cross brace 108. This tilt is due to the angle of the dovetail slot 214 with respect to the vertical axis of the top rail 104 opposing the downward force in the direction of the vertical axis of the top rail of an item placed on the sawhorse. A similar action would take place when using an inset slot or other type of joint.

Thus, using the above-described configuration, the joints interconnecting the leg members 106 with the top rail 104 and the cross brace 108 will provide stronger and more stable joints when a weight upon the top rail 104 forces the top rail 104 in a downward direction. Thus, the portable sawhorse 102 becomes more stable and able to support more weight responsive to the placement of a weight upon the sawhorse 102.

It will be appreciated by those skilled in the art having the benefit of this disclosure that this portable sawhorse provides an improved structure for supporting greater weights. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A sawhorse, comprising:
a top rail for supporting an item placed on the sawhorse, the top rail defining at least four inset slots with at least two of the at least four inset slots located on lateral sides of the top rail;
at least four leg members for supporting the top rail, a first end of the at least four leg members for engaging a corresponding inset slot of the at least four inset slots to form a joint; and
wherein responsive to a downward force applied to the top rail by the item placed on the sawhorse, the first end of each of the at least four leg members will cause sides of the first end within the corresponding inset slot within the top rail to engage sides of the inset slot to stabilize the joint.

2. The sawhorse of claim 1 further including:
a cross brace for interconnecting a pair of the at least four leg members, the cross brace defining a pair of second inset slots on opposite ends thereof;
wherein the at least four leg members define a second guide for engaging a corresponding one of the pair of second inset slots on the cross brace to form a second joint; and
wherein responsive to the downward force applied to the top rail by the item placed on the sawhorse, the second guide on the at least four leg members will cause sides of the second guide within the corresponding inset slot within the cross brace to engage sides of the second inset slot to stabilize the second joint.

3. The sawhorse of claim 1 further including a support brace interconnecting an assembly including a pair of the at least four leg members to a bottom of the top rail, wherein the support brace limits movement of the assembly including the pair of the at least four leg members along a horizontal axis of the top rail.

4. The sawhorse of claim 3 further including a second support brace interconnecting a second assembly including a second pair of the at least four leg members to the bottom of the top rail, wherein the second support brace limits movement of the second assembly including the second pair of the at least four leg members along the horizontal axis of the top rail, wherein the support brace and the second support brace interconnect to the bottom of the top rail at a same point.

5. The sawhorse of claim 1 further including a plurality of fasteners, wherein each of the plurality of fasteners passes through the joints comprised of the dovetails on the first end of a pair of the at least four leg members and the corresponding dovetail slots defined in the top rail.

6. The sawhorse of claim 1, wherein the inset slots comprises dovetail slots with a dovetail cut defined on each closed side of the inset slot and the first end of the at least four leg members include a dovetail for engaging the dovetail slots.

7. The sawhorse of claim 6 wherein responsive to a downward force applied to the top rail by the item placed on the sawhorse, the first end of each of the at least four leg members will tilt within the corresponding dovetail slot within the top rail causing sides of the dovetail to engage sides of the dovetail slot to stabilize the joint.

8. A sawhorse, comprising:
a top rail for supporting an item placed on the sawhorse, the top rail defining at least four dovetail slots with at least two of the at least four dovetail slots located on lateral sides of the top rail;
at least four leg members for supporting the top rail, a first end of the at least four leg members defining a dovetail for engaging a corresponding dovetail slot of the at least four dovetail slots to form a joint; and
wherein responsive to a downward force applied to the top rail by the item placed on the sawhorse, the dovetail on the first end of each of the at least four leg members will tilt within the corresponding dovetail slot within the top rail causing sides of the dovetail to engage sides of the dovetail slot to stabilize the joint;
a cross brace for interconnecting a pair of the at least four leg members, the cross brace defining a pair of second dovetail slots on opposite ends thereof;
wherein the at least four leg members define a second dovetail for engaging a corresponding one of the pair of second dovetail slots on the cross brace to form a second joint; and
wherein responsive to the downward force applied to the top rail by the item placed on the sawhorse, the second dovetail on the at least four leg members will tilt within the corresponding dovetail slot within the cross brace causing sides of the second dovetail to engage sides of the second dovetail slot to stabilize the second joint.

9. The sawhorse of claim 8 further including a support brace interconnecting an assembly including a pair of the at least four leg members to a bottom of the top rail, wherein the support brace limits movement of the assembly including the pair of the at least four leg members along a horizontal axis of the top rail.

10. The sawhorse of claim 9 further including a second support brace interconnecting a second assembly including a second pair of the at least four leg members to the bottom of the top rail, wherein the second support brace limits movement of the second assembly including the second pair of the at least four leg members along the horizontal axis of the top rail, wherein the support brace and the second support brace interconnect to the bottom of the top rail at a same point.

11. The sawhorse of claim 8 further including a plurality of fasteners, wherein each of the plurality of fasteners passes through the joints comprised of the dovetails on the first end of a pair of the at least four leg members and the corresponding dovetail slots defined in the top rail.

12. A sawhorse, comprising:
a top rail for supporting an item placed on the sawhorse, the top rail defining at least four dovetail slots with at least two of the at least four dovetail slots located on lateral sides of the top rail;
at least four leg members for supporting the top rail, a first end of the at least four leg members defining a dovetail for engaging a corresponding dovetail slot of the at least four dovetail slots to form a joint; and
wherein responsive to a downward force applied to the top rail by the item placed on the sawhorse, the dovetail on the first end of each of the at least four leg members will tilt within the corresponding dovetail slot within the top rail causing sides of the dovetail to engage sides of the dovetail slot to stabilize the joint;
a plurality of cross braces, each of the plurality of cross braces for interconnecting a pair of the at least four leg members, the plurality of cross braces each defining a pair of second dovetail slots on opposite ends thereof;
wherein the at least four leg members define a second dovetail for engaging a corresponding one of the pair of second dovetail slots on the cross brace to form a second joint;
wherein responsive to the downward force applied to the top rail by the item placed on the sawhorse, the second dovetail on the at least four leg members will tilt within the corresponding dovetail slot within the cross brace causing sides of the second dovetail to engage sides of the second dovetail slot to stabilize the second joint;
a plurality of support braces each interconnecting one of the plurality of cross braces to a bottom of the top rail at a same point, wherein the plurality of support braces limit movement of the support braces along a horizontal axis of the top rail.

13. The sawhorse of claim 12 further including a plurality of fasteners, wherein each of the plurality of fasteners passes through the joints comprised of the dovetails on the first end of a pair of the at least four leg members and the corresponding dovetail slots defined in the top rail.
